(19) United States
(12) Patent Application Publication
(10) Pub. No.: US 2025/0231997 A1
(43) Pub. Date: Jul. 17, 2025

(54) PRIVATE PRE-FETCHING OF SEARCH RESULTS

(71) Applicant: Google LLC, Mountain View, CA (US)

(72) Inventor: Florian Hartmann, Zurich (CH)

(21) Appl. No.: 18/992,891

(22) PCT Filed: Aug. 5, 2022
(86) PCT No.: PCT/US2022/074617

§ 371 Date: Jan. 9, 2025

Related U.S. Application Data
(60) Provisional application No. 63/368,568, filed on Jul. 15, 2022.

(51) Int. Cl. G06F 16/957; H04L 9/40

(52) U.S. Cl. CPC G06F 16/9574; H04L 63/0428

(57) ABSTRACT

Systems and methods enable private pre-fetching of search results. For example, methods may include detecting a prefetch trigger associated with a content portion of content provided by a client device, and encrypting the content portion, in response to the prefetch trigger, to obtain an encrypted content portion. The encrypted content portion may be transmitted to a search server, and encrypted search results may be received from the search server. The example methods may include receiving a search request based on the content portion, decrypting the encrypted search results to obtain decrypted search results, and providing the decrypted search results at the client device.

### CROSS-REFERENCE TO RELATED APPLICATION

This application claims priority to U.S. Provisional Patent Application No. 63/368,568, filed on Jul. 15, 2022, the disclosure of which is incorporated by reference herein in its entirety.

### TECHNICAL FIELD

This description relates to providing search results.

### BACKGROUND

Search engines are generally designed to provide search results as quickly as possible in response to search requests (queries). Even small delays in search result response times may have detrimental effects on user experiences. For example, users may abandon a search, may spend less time reviewing search results, or may use a different search engine to obtain the search results.

There are many factors, however, that may cause delays in providing search results. For example, a search may be required to perform extensive processing of large quantities of potential search results, which may be distributed across a network. In other examples, even if the search results may be obtained quickly, there may be network delays that extend the time needed to provide the search results.

### SUMMARY

Implementations provide pre-fetching of search results by initiating searches prior to receiving a search request from a user. For example, some implementations may detect that a user has selected text (e.g., to be copied and pasted), and may initiate a search using the text, even before the user has pasted the text into a search field. Then, if the user does paste the text into the search field and submit a search request, the corresponding search results may already have been obtained, and may be provided extremely quickly in response to the search request. Latency is therefore reduced.

In other examples, described implementations may examine content provided to a user, and may identify, extract, and classify text within the content. In this way, again, such text may be used to prefetch search results, which may then be provided very quickly if needed.

In the preceding and other types of pre-fetching, described implementations ensure a privacy of users for whom the pre-fetching is performed. For example, described implementations may encrypt the text used for the pre-fetching of search results, and the search engine performing the search may perform the search without ever decrypting or otherwise having access to the text. For example, the search engine may generate the search results using a commutative process in which the encrypted text is never decrypted, and in which the search results are provided in encrypted form and are only accessible by a client device of the user.

Consequently, users may be advantageously provided with search results very quickly, even when the search process is complex or lengthy, or when network conditions are poor, or when client devices of the user are slow. As a result, users are more likely to be satisfied with a search engine providing the search results, and with the search results themselves.

In a general aspect, a computer program product may be tangibly embodied on a non-transitory computer-readable storage medium and may include instructions that, when executed by at least one computing device, are configured to cause the at least one computing device to detect a prefetch trigger associated with a content portion of content provided by a client device, encrypt the content portion, in response to the prefetch trigger, to obtain an encrypted content portion, transmit the encrypted content portion to a search server, receive encrypted search results from the search server, receive a search request based on the content portion, decrypt the encrypted search results to obtain decrypted search results, and provide the decrypted search results at the client device. In other general aspects, the same or similar features may be implemented as a method, a system, or a device(s).

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for private pre-fetching of search results in accordance with example implementations.

FIG. 2 is a flowchart illustrating example operations of the system of FIG. 1.

FIG. 3 is a timing diagram illustrating example pre-fetching operations of the system of FIG. 1.

FIG. 4 is a flowchart illustrating example operations of a search engine of the system of FIG. 1.

FIG. 5 shows an example of a computer device that can be used to implement the described techniques.

FIG. 6 shows an example of a distributed computer device that can be used to implement the described techniques.

### DETAILED DESCRIPTION

Described systems and techniques solve the problem of providing fast, accurate search results, in a manner that preserves user privacy. Disclosed implementations proactively identify and obtain, from content provided to a user, text to be used to prefetch search results. For example, disclosed implementations may obtain such text by detecting user selections of text from among the content, and/or by performing text extraction and classification from the content. The text may then be encrypted, and the encrypted text may be provided to a search server to perform a corresponding search, before the user has requested the corresponding search to be performed. The search server may perform the search of the encrypted text without ever decrypting or otherwise gaining access to the text, and may provide encrypted search results. Then, if the user does request the corresponding search, e.g., by pasting the text into a search field, described implementations may decrypt and provide the prefetched search results to the user, in much less time than would have been required without the described pre-fetching techniques.

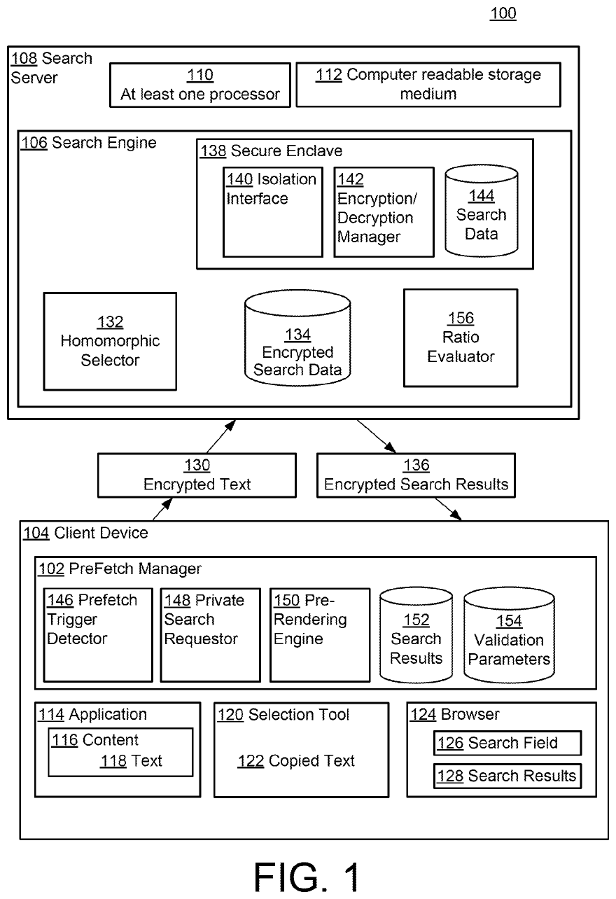

FIG. 1 is a block diagram of a system for private pre-fetching of search results in accordance with example implementations. In the system of FIG. 1, a prefetch manager 102 may be configured to provide the types of private pre-fetching of search results referenced above and described in more detail, below.

In more detail, the depiction of system 100 in FIG. 1 may be understood and described, for example, as a search service for content accessible by the Internet that is configured to provide private pre-fetching of search results, using the prefetch manager 102. Other configurations and applications of the described technology may be used. In other examples, private pre-fetching may be provided in similar interactions with non-Internet sources, such as a company's internal documents or items in a corpus secured by a login (e.g., a members-only library). Implementations can be applied in any setting where a search service provides search results, e.g., via a browser.

The prefetch manager 102 may be provided using a client device 104, where the client device 104 may represent, in various examples, a personal computer, a workstation, a laptop computer, or a tablet computer. The client device 104 may also represent a device such as a smartphone, smartglasses, smartwatch, or any device capable of performing the types of searches described herein, or similar searches. Accordingly, the client device 104 may include various hardware and software components not illustrated in the simplified example of FIG. 1.

The client device 104 may be in communication with a search engine 106 executing on a search server 108. The search engine 106 and the search server 108 may represent computing devices that take the form of a number of different devices, for example a standard server, a group of such servers, or a rack server system. In additional or alternative examples, the search engine 106 may be implemented in a personal computer, for example a laptop computer. The search engine 106 may be provided using the search server 108, representing one or more servers that receive queries from a requestor, such as from the client device 104. Like the client device 104, the search engine 106 may include various hardware and software components not illustrated in the simplified example of FIG. 1, such as an operating system.

The search engine 106 may be a system using components such as processors and memories, illustrated in FIG. 1 as at least one processor 110 and non-transitory computer-readable storage medium 112. For example, the computer-readable storage medium 112 may represent any kind of memory (e.g., RAM, flash, cache, disk, tape, etc.). The computer-readable storage medium 112 may represent multiple kinds of memory. In some implementations (not shown) the computer-readable storage medium 112 may include external storage, e.g., memory physically remote from but accessible by the search engine 106

As described in detail, below, both the client device 104 and the search engine 106 may include one or more modules or engines representing specially programmed software. For example, the client device 104 may be configured to provide an application 114. The application 114 may represent any locally-executed and/or network-accessible program capable of rendering, displaying, or otherwise providing content 116, where the content 116 includes various types and amounts of text, including text 118 in the example of FIG. 1.

For example, the application 114 may represent any word processing application, presentation software, spreadsheet software, email software, or calendar software. In other examples, the application 114 may represent an app obtained from an app store. In other examples, the application 114 may represent a browser and/or a web application accessed over the Internet.

The content 116 may thus represent any visual or audible content accessed or provided by or to the application 114. For example, the content 116 may represent a document, a spreadsheet, an email, or a text. In various examples, the content 116 may be entered into the application by a user or may be generated by the application 114 in the context of operations of the application 114.

In example embodiments of the system 100 of FIG. 1, the content 116 may include text 118. A selection tool 120 may be configured to select the text 118, or any other content portion of the content 116, for one of a plurality of purposes. For example, the text 118 may be selected in order to modify or delete the text 118 within the application 114, or to determine information related to the text 118 (e.g., to find a synonym or antonym).

The selection tool also may be used to copy the text 118, illustrated in FIG. 1 as copied text 122. For example, the selection tool 120 may be provided at least partially by an operating system of the client device 104 and may be configured to interface with multiple applications of the client device 104. For example, the selection tool 120 may be configured to interface with multiple applications to copy text therefrom for storage using designated memory, which may be referred to as a clipboard.

Accordingly, the selection tool 120 may enable copying of text from one application (e.g., the application 114) for pasting into another application, such as a browser application 124. For example, the browser application 124 may be used to access a search website provided by the search engine 106, which provides a search field 126. Upon pasting of the copied text 122 into the search field 126, and associated submission of the pasted text to the search engine 106, the search engine 106 may provide corresponding search results 128.

Thus, FIG. 1 generally demonstrates, for the sake of illustration and explanation, that a user may wish to perform searches using the copied text 122. In other examples, the user may simply re-type the text 118 directly into the search field 126 to obtain the search results 128. In still other examples, the application 114 and the browser application 124 (or multiple pages or tabs provided by the browser application 124) may interface with one another to enable the user to initiate a desired search directly from the application 114 (or other current user context).

In these and other examples, there is a waiting time that exists between a time that the user initiates a search and a time that the search results 128 are received and rendered to the user, e.g., at the browser application 124. As described above, there are multiple sources of potential delay associated with this waiting time. Moreover, even when this waiting time is optimized in conventional search systems, some percentage of users may find the waiting time to be excessive. For example, some users may move on to another search, or may review the search results 128 less thoroughly, or may stop searching altogether.

In the system 100 of FIG. 1, however, the prefetch manager 102 is configured to initiate a search of the text 118 prior to the user initiating a search of the text 118, in the context of techniques referred to herein as pre-fetching. In order to preserve a privacy of the user in performing such pre-fetching of search results, the prefetch manager 102 may encrypt the text 118 to obtain encrypted text 130, as described in more detail, below.

The search engine 106 may be configured to implement one or more techniques for performing searching using the encrypted text 130. For example, a homomorphic selector 132 may be configured to compare the encrypted text 130 against encrypted search data 134. Using properties of homomorphic encryption, as also described below, the homomorphic selector 132 may match the encrypted text 130 against the encrypted search data 134 to retrieve and obtain encrypted search results 136, which may then be provided to the client device 104.

In other examples, the search engine 106 may include a secure enclave 138. The secure enclave 138 provides a hardware-based solution for using the encrypted text 130 to provide the encrypted search results 136, in the sense that the secure enclave 138 may include, e.g., a dedicated memory or memory portion of the at least one computer readable storage medium 112, and/or a dedicated processor or processor circuit or subsystem of the at least one processor 110. As described in more detail, below, the secure enclave 138 may be configured to appear as an opaque element to a remainder of the search engine 106, so that the encrypted text 130 may be processed in a secure, confidential manner.

For example, the secure enclave 138 may include an isolation interface 140 configured to receive the encrypted text 130. The secure enclave 138 may include an encryption/decryption manager 142 that may be configured to decrypt the encrypted text 130 and use the resulting decrypted text (e.g., the text 118) to perform a search against search data 144. Subsequent search results may be encrypted by the encryption/decryption manager 142 and provided through the isolation interface 140 as the encrypted search results 136. It will be appreciated that other techniques may be used to ensure privacy of search results when processing the encrypted text 130 to provide the encrypted search results 136.

Accordingly, the prefetch manager 102 may be configured to initiate virtually any pre-fetching operations with respect to the content 116, including pre-fetching search results for the text 118 and other text, image, or content portion of the content 116, without sacrificing a privacy of the user of the application 114. Therefore, the prefetch manager 102 may significantly reduce or eliminate the waiting time between a submission of a search by a user and subsequent providing of corresponding search results to that user.

The prefetch manager 102 may include a prefetch trigger detector 146 that may be configured to detect one or more prefetch triggers for initiating prefetch operations for the text 118 or other content portion of the content 116. That is, a prefetch trigger as used herein refers to any operation of the application 114, the selection tool 120, and/or the browser application 124, which may occur automatically and/or in response to an action of a user, that has been predefined for detection by the prefetch trigger detector 146.

For example, a prefetch trigger may include any selection of the text 118, e.g., by the selection tool 120. That is, upon detection of a selection of the text 118 by the selection tool 120, the prefetch trigger detector 146 may be configured to cause a private search requestor 148 to encrypt the text 118 to obtain encrypted text 130, and to forward the encrypted text 130 to the search engine 106 for searching to be conducted thereon (e.g., using the homomorphic selector 132 and the encrypted data 134, and/or using the secure enclave 138). Since the selection tool 120 is an existing functionality, no additional memory storage is required for the code needed to implement the selection functionality.

Many other prefetch triggers may be defined, as well. For example, when a user of the application 114 initially loads or displays the content 116, the prefetch trigger detector 146 may be configured to analyze the content 116 to identify text entities or other content portions to be submitted to the private search requestor 148, even if the user has not selected the text 118 or any other content portion at that point in time. In such cases, the prefetch trigger may be understood to include, e.g., a loading/displaying of the content 116 and/or a successful recognition of the text 118 or other designated content portion by the prefetch trigger detector 146.

In some examples, the prefetch trigger detector 146 may be configured to capture any searchable content portions of the content 116, i.e., any content portion (or type of content portion) that the prefetch trigger detector 146 recognizes as being capable of being submitted to the private search requestor 148 for processing by the search engine 106. In such scenarios, the prefetch trigger detector 146 may initiate a large number of prefetch searches by the private search requestor 148.

For example, upon loading of a page by the application 114, the prefetch trigger detector 146 may parse the content 116 and determine every available text entity included therein. In this context, a text entity refers to any word or phrase within the content 116 that may be recognized and classified as a person, place, thing, or idea. The prefetch trigger detector 146 may use any suitable natural language processing (NLP), machine learning (ML), or artificial intelligence (AI) available for performing such text entity detection.

In such examples, the prefetch trigger detector 146 may submit a large number of content portions to the private search requestor 148. For example, every time a user loads a new page of the application 114, the prefetch trigger detector 146 may extract all included text entities for submission to the private search requestor 148. Accordingly, a large number of searches may be performed by the search engine 106, even though the user may not ultimately decide to request any such searches to be performed (e.g., may not separately submit any of the recognized text entities using the search field 126). Consequently, such a configuration of the prefetch trigger detector 146 may use significant quantities of resources of the search server 108.

In other examples, the prefetch trigger detector 146 may be configured to identify content portions of the content 116 for submission to the private search requestor 148 in a more selective or restricted manner. For example, the prefetch trigger detector 146 may implement a classification model that classifies parsed text entities to determine a subset of parsed text entities to be submitted to the private search requestor 148.

Such a classification model may be implemented in any desired manner, and with any desired degree of selectivity. Additional examples of classification techniques used by the prefetch trigger detector 146 are provided below, or would be apparent. Such selective methods can reduce the amount of processing required and bandwidth used, while continuing to deliver extremely low latency search results.

In some cases, classification operations of the prefetch trigger detector 146 may impact subsequent operations of the private search requestor 148, as well, such as operations related to selecting the search engine 106 from among multiple possible search engines. For example, if the prefetch trigger detector 146 classifies the text 118 as a location, the private search requestor 148 may be configured to submit the text 118 to a location-based (e.g., mapping) search engine. In these and similar examples, the private search requestor 148 may also be configured to determine appropriate types of encryption to be used, as well.

Upon receipt of the encrypted search results 136, the private search requestor 148 may decrypt the encrypted search results 136, e.g., for rendering by a pre-rendering engine 150 and/or storage in search results 152. For example, the encrypted search results 136 may be stored in encrypted form within the search results 152 until a search request for a particular set of search results is received, at which point decryption may occur. In other examples, the encrypted search results 136 may be immediately decrypted and pre-rendered by the pre-rendering engine 150, so that a particular set of search results may be provided immediately upon receipt of a corresponding search request.

As noted above, the prefetch trigger detector 146 may be configured to detect and submit large numbers of search requests to the private search requestor 148, e.g., such as when content selection and classification operations of the prefetch trigger detector 146 are defined broadly. In such scenarios, it is likely that a relatively large burden may be placed on the search engine 106, even though only a small percentage of such searches may be used by a user of the application 114. On the other hand, it is more likely that a search submitted by the user will already have been conducted (or is in the process of being conducted) when the user submits a search request.

To avoid over-burdening the search engine 106 while still ensuring a convenience of the user in obtaining search results very quickly, the prefetch trigger detector 146 may be configured to optimize a number, percentage, or ratio of search requests submitted to the private search requestor 148, using a variety of techniques, some of which are described herein. For example, various validation parameters 154 may be maintained to used by the prefetch trigger detector 146 in detecting prefetch triggers.

For example, the validation parameters 154 may include or identify previously-conducted searches, or types of searches, performed by the prefetch manager 102, which were later requested by a user using the search field 126 and then provided in the search results 128. In other words, the validation parameters 154 may identify or reflect the subset of prefetch triggers that were ultimately used by a user of the application 114 (e.g., submitted using the search field 126). This thereby reduces processing and bandwidth usage, while also reducing latency.

The validation parameters 154 may be accumulated over time at the client device 104, and may also be updated and/or maintained remotely at the search engine 106, e.g., across a plurality of client devices. For example, the search engine 106 may maintain a ratio evaluator 156 that is configured to track, over a period of time, searches submitted using the search field 126 and corresponding to searches performed by the private search requestor 148, as compared to all the searches submitted by the private search requestor 148.

When the resulting ratio is relatively low, then the search engine 106 is performing large numbers of searches that are not actually being used, which may be undesirably burdensome to operations of the search server 108. On the other hand, when the resulting ratio is relatively high, then it is more likely that the prefetch manager 102 may be overly selective, and may be missing opportunities for providing the advantages of prefetch searching as described herein.

Consequently, the ratio evaluator 156 may be used to optimize or otherwise configure a selectivity of the prefetch trigger detector 146. For example, the ratio evaluator 156 may update the validation parameters 154. In other examples, classification model(s) of the prefetch trigger detector 146 may have varying degrees of selectivity, which may be updated by (or using) the ratio evaluator 156. Processing, bandwidth and latency can therefore be balanced alongside optimizing quality of search results.

The above examples are non-limiting, and other techniques may be used to configure and optimize a selectivity of the prefetch trigger detector 146. For example, the search engine 106 may track popularity of search terms and search results across users, independently of use of the prefetch trigger detector 146. The prefetch trigger detector 146 may then use resulting statistics to govern a selectivity of prefetch trigger detection.

For example, the validation parameters 154 may include highly popular search terms, or highly popular search terms that are specific to a user profile of a user of the client device 104 or to the application 114. Then, the prefetch trigger detector 146 may initially select a subset of content portions (e.g., text entities) from the content 116, and then filter the subset using the popular search terms included in the validation parameters 154.

In the example of FIG. 1, the prefetch manager 102 is illustrated as a separate component within the client device 104. In other examples, however, the prefetch manager 102, or individual components thereof, may be implemented using the application 114, the selection tool 120, the browser application 124, and/or the search engine 106. The client device 104 may also represent multiple client devices in communication with one another, such as a watch or smartglasses in communications with a smartphone or laptop computer. Many other example implementations are possible, as well, some of which are described in more detail below.

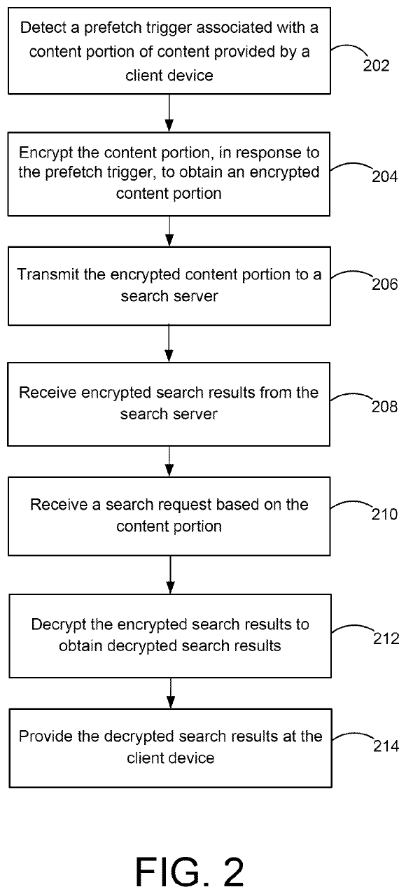

FIG. 2 is a flowchart illustrating example operations of the system of FIG. 1. In the example of FIG. 2, operations 202-206 are illustrated as separate, sequential operations. However, in various example implementations, the operations 202-206 may be implemented in a different order than illustrated, in an overlapping or parallel manner, and/or in a nested, iterative, looped, or branched fashion. Further, various operations or sub-operations may be included, omitted, or substituted.

In FIG. 2, a prefetch trigger associated with a content portion of content provided by a client device may be detected (202). For example, the prefetch trigger detector 146 may detect a prefetch trigger with respect to the content 116 of the application. As described, the prefetch trigger may include selection of the text 118 as the content portion, e.g., by the selection tool 120. The prefetch trigger may include loading of the content 116 by the application 114 and associated parsing thereof by the prefetch trigger detector 146 to identify and classify text entities (e.g., as a specific type(s) of text) or other content portions, or combinations thereof. The prefetch trigger may be based on, or may use, various factors such as a context of the application 114 (e.g., a type or state of the application 114). The prefetch trigger may be defined with respect to various types of the validation parameters 154, such as popularity of search terms, a search history of the user, or a search history of previously-determined prefetch search terms or search results (or use thereof by the user). The prefetch trigger may also be defined with respect to a type of content portion determined, e.g., text, images, or audio.

The content portion may be encrypted, in response to the prefetch trigger, to obtain an encrypted content portion (204). For example, when the content portion includes text, the private search requestor 148 may encrypt the text to obtain encrypted text. When the prefetch trigger and associated content portion are determined with respect to search parameters of the validation parameters 154, the private search requestor 148 may include (encrypt) the search parameters with the encrypted content portion. For example, when the content portion (e.g., the text 118) is defined as having a specific type, or requiring a specific type of search, such information may be include in or with the encrypted text 130 transmitted to the search engine 106. For example, if the text 118 is classified as a name of a person, where the name is shared by a musician a politician, the prefetch trigger detector 146 may classify the name as corresponding to the musician and the private search requestor 148 may limit the requested search accordingly.

The encrypted content portion may be transmitted to a search server (206). For example, the private search requestor 148 may transmit the encrypted text 130 to the search engine 106. As described, the private search requestor 148 may select the search engine 106 from among a number of potential search engines, based on the prefetch trigger detection operations of the prefetch trigger detector 146 (e.g., based on a classification of the text 118). The private search requestor 148 may configure the search request based on the search engine being used. For example, different encryption techniques may be used.

Encrypted search results may be received from the search server (208). For example, the encrypted search results 136 may be received at either the private search requestor 148 or the pre-rendering engine 150, and may be stored locally as search results 152. The encrypted search results may be decrypted upon receipt, or may be decrypted at a later stage, e.g., following a corresponding search request from a user. The latter approach prevents wasted processing in the event the user does not start a corresponding search, as such processing can be reduced. Similarly, the pre-rendering engine 150 may immediately pre-render decrypted search results, or may begin rendering as soon as a corresponding search request is received.

A search request based on the content portion may be received (210). For example, the content portion, e.g., the text 118, may be typed into the search field 126, or may be pasted into the search field 126 using the copied text 122. In other examples, the application 114 may be configured to enable submission of the search request directly from the application 114, perhaps in conjunction with use of the selection tool 120. As described herein, the search request may occur while the pre-fetching is occurring, or may occur after the pre-fetching has completed (e.g., after the search results 152 have been received and/or decrypted, or after pre-rending has occurred at the pre-rendering engine 150).

The encrypted search results may be decrypted to obtain decrypted search results (212). For example, either the private search requestor 148 and/or the pre-rendering engine 150 may be configured to provide decryption of the encrypted search results 136/

The decrypted search results may be provided at the client device (214). For example, the search results 152 may be provided at the client device 104. For example, the pre-rendering engine 150 may pre-render the search results 152 for immediate rendering by the browser application 124 upon receipt of a corresponding search request. In other examples, the prefetch manager 102 may provide the decrypted search results to the browser application 124 for rendering.

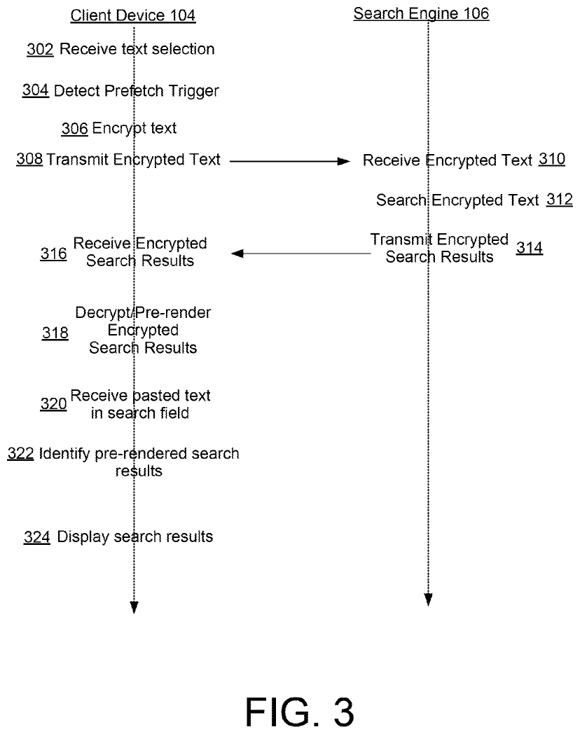

FIG. 3 is a timing diagram illustrating example pre-fetching operations of the system of FIG. 1. In the example of FIG. 3, at a time 302, a text selection is received. For example, the text 118 may be selected by the selection tool 120.

At a time 304, a corresponding pre-fetch trigger is detected. For example, as described above, the act of selection may be sufficient to define occurrence of a prefetch trigger. In other examples, criteria may be required, as well. For example, the selection may be required to occur in conjunction with other operations, contexts or states of the application 114. In other examples, the selection may be validated as a prefetch trigger against validation parameters 154. Starting the processing of search results so early not only reduces latency when a search is initiated by a user, but also reduces burden on a network for speed of transmission of data and reduces the need for such high power processing to achieve fast search results.

At a time 306, the text may be encrypted to obtain the encrypted text 130. Encryption may include encryption of other search parameters used to limit or define searching based on the encrypted text 130. Then, at a time 308, the encrypted text may be transmitted to the search engine 106.

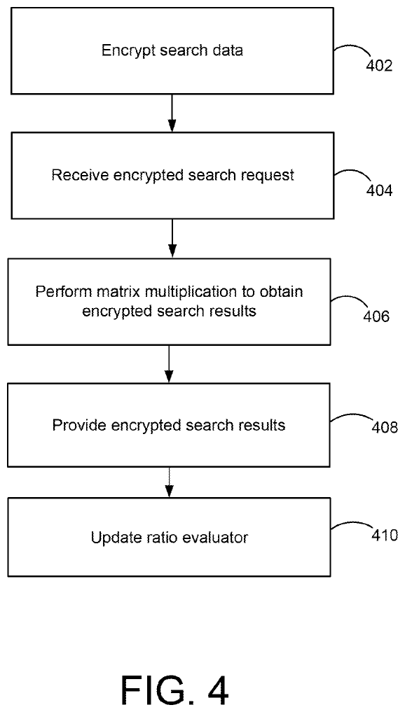

At the search engine 106, at a time 310, the encrypted text is received. At a time 312, the encrypted text is searched without being decrypted. For example, as referenced above and described in more detail below, with respect to FIG. 4, the search engine 106 may perform homomorphic selection of encrypted search results, using the encrypted text. In other examples, the search engine 106 may use the secure enclave 138, or similar technology, to search the encrypted text without making any decrypted version of the encrypted text available at the search engine 106, or otherwise outside of the client device 104. Then, at a time 314, the search engine 106 may transmit the encrypted search results to the client device 104. This increases security and privacy. In addition, less processing is required because data is not decrypted and encrypted multiple times, but instead, for example, the encrypted data may be processed.

At a time 316, the client device 104 may receive the encrypted search results. At a time 318, the client device 104 may decrypt and pre-render the encrypted search results.

At a time 320, the copied text 122 may be received at the client device 104, e.g., may be pasted into the search field 126 in conjunction with a submission of the pasted text using a submit button associated with the search field 126. In other words, as illustrated by FIG. 3, the search results may be obtained during a time between times 302 and 320, and prior to receipt of the selection of a submit button or other proactive request for a corresponding search received from the user.

At a time 322, the client device 104 may identify pre-rendered search results. For example, when a submit button of the search field 126 is selected by a user, the prefetch manager 102 may detect the corresponding search request and search parameters, which may then be used to detect the search results corresponding to the text 118. Accordingly, at a time 324, the search results may be displayed.

For example, the search results 152 may contain search results for many different content portions of the content 116, all of which have been used to conduct pre-fetching as described herein. For example, a user may make multiple selections of multiple text entities of the content 116. In other examples, the prefetch trigger detector 146 may also select text entities using the classification techniques described above.

In these and other examples, the prefetch manager 102 may conduct 10, 20, 100, or more searches, based on the various prefetch triggers detected. Accordingly, the search results 152 may include or identify a corresponding 10, 20, 100, or more sets of search results within the search results 152. Thus, at the time 322 when pre-rendered search results are identified the prefetch manager 102 may be configured to inspect the search results 152 to identify, from among the various pre-fetched search results contained therein, which search results correspond to the currently received text.

The search results 152 may consume memory of the client device 104, and various techniques may be used to limit excessive quantities of memory from being allocated for use in storing the search results 152. For example, contents of the search results 152 may be deleted after a period of time. In other examples, the search results 152 may be filtered, e.g., using the validation parameters 154.

In other examples, the search results 152 may be limited to a subset of search results, e.g., the most popular or most-closely matched search results. For example, when the prefetch manager 102 performs 10, 20, 100, or more prefetch searches, the prefetch manager 102 may limit the search results for each such search to an initial search result subset. Subsequently, if a particular search is performed for a particular content portion (e.g., for the text 118 as described herein), then a more complete set of search results may be obtained while the initial set of pre-fetched search results are provided to the user for review.

More generally, at the time 320 at which the pasted text is received and a search request is submitted by the user, the system 100 of FIG. 1 may initiate a conventional search in conjunction with the operations at times 322, 324. Such an approach optimizes use of the resources of the client device 104, while also enabling the search engine 106 to perform any conventional or other usage analysis that would be performed in conjunction with such a conventional search of the text 118.

FIG. 4 is a flowchart illustrating example operations of the search engine 106 of the system of FIG. 1. In the example of FIG. 4, search data of the search engine 106 is encrypted to provide the encrypted search data 134 (402). For example, public and private/secret key encryption techniques may be used to generate cyphertext that can not be decrypted without the private key. When encrypted using homomorphic encryption techniques, it is possible to perform complex mathematical operations using the cyphertext, without decrypting the cyphertext.

For example, when the search engine 106 receives the encrypted text 130 or other encrypted search request(s) (404), the homomorphic selector 132 may perform matrix multiplication of the encrypted text 130 against the encrypted search data 134 (406). This process will return the encrypted search results 136, without revealing the encrypted search data 134. Accordingly, the encrypted search results 136 may be provided to the client device 104 (408).

The search engine 106 may update the ratio evaluator 156 (410). For example, the search engine 106 may receive, from the client device 104, a percentage of user-initiated searches for which pre-fetched search results were previously obtained. The search engine 106 may receive such percentages from multiple client devices, without receiving any specifics regarding the content of the encrypted text 130 or other private data.

In this way, the search engine 106 may instruct the prefetch manager 102 to update the prefetch trigger detector 146 to be more or less selective when identifying a prefetch trigger used to initiate a prefetch search operation. Moreover, the search engine 106 may be configured to provide such instructions regarding levels of prefetch trigger selectivity across a network of client devices, or for an individual client device/user.

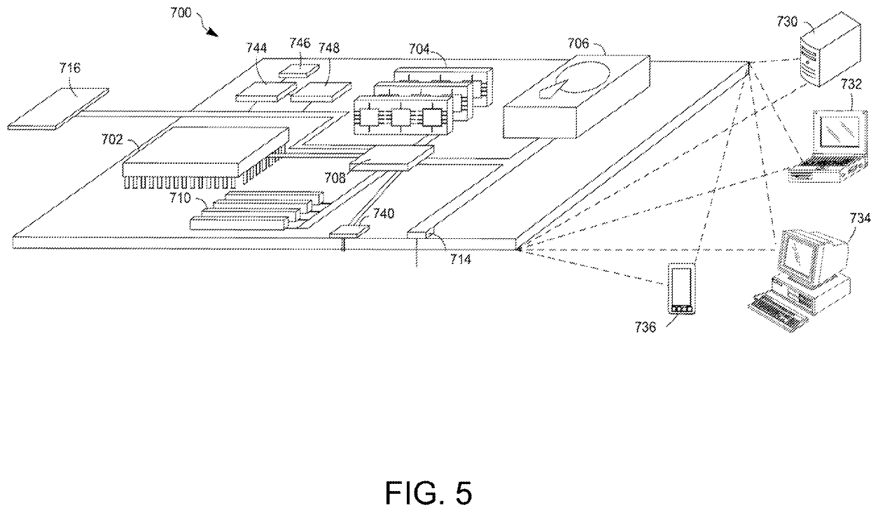

FIG. 5 shows an example of a generic computer device 700, which may be operated as search engine 106 and/or client device 104 of FIG. 1, which may be used with the techniques described herein. Computing device 700 is intended to represent various example forms of computing devices, such as laptops, desktops, workstations, personal digital assistants, cellular telephones, smartphones, tablets, televisions, servers, and other computing devices, including wearable devices. The components shown here, their connections and relationships, and their functions, are meant to be examples only, and are not meant to limit implementations of the inventions described and/or claimed in this document.

Computing device 700 includes a processor 702, memory 704, a storage device 706, and expansion ports 710 connected via an interface 708. In some implementations, computing device 700 may include transceiver 746, communication interface 744, and a GPS (Global Positioning System) receiver module 748, among other components, such as a camera or cameras, touch sensors, keyboards, etc., connected via interface 708. Device 700 may communicate wirelessly through communication interface 744, which may include digital signal processing circuitry where necessary. Each of the components 702, 704, 706, 708, 710, 740, 744, 746, and 748 may be mounted on a common motherboard or in other manners as appropriate.

The processor 702 can process instructions for execution within the computing device 700, including instructions stored in the memory 704 or on the storage device 706 to display graphical information for a GUI on an external input/output device, such as display 716. Display 716 may be a monitor or a flat touchscreen display. In some implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk. In some implementations, the memory 704 may include expansion memory provided through an expansion interface.

The storage device 706 is capable of providing mass storage for the computing device 700. In one implementation, the storage device 706 may be or include a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in such a computer-readable medium. The computer program product may also include instructions that, when executed, perform one or more methods, such as those described above. The computer-or machine-readable medium is a storage device such as the memory 704, the storage device 706, or memory on processor 702.

The interface 708 may be a high speed controller that manages bandwidth-intensive operations for the computing device 700 or a low speed controller that manages lower bandwidth-intensive operations, or a combination of such controllers. An external interface 740 may be provided so as to enable near area communication of device 700 with other devices. In some implementations, controller 408 may be coupled to storage device 706 and expansion port 714. The expansion port, which may include various communication ports (e.g., USB, Bluetooth, Ethernet, wireless Ethernet) may be coupled to one or more input/output devices, such as a keyboard, a pointing device, a scanner, a camera or cameras, or a networking device such as a switch or router, e.g., through a network adapter.

The computing device 700 may be implemented in a number of different forms, as shown in the figure. For example, it may be implemented as a standard server 730, or multiple times in a group of such servers. It may also be implemented as part of a rack server system. In addition, it may be implemented in a computing device, such as a laptop computer 732, personal computer 734, or tablet/smart phone 736. An entire system may be made up of multiple computing devices 700 communicating with each other. Other configurations are possible.

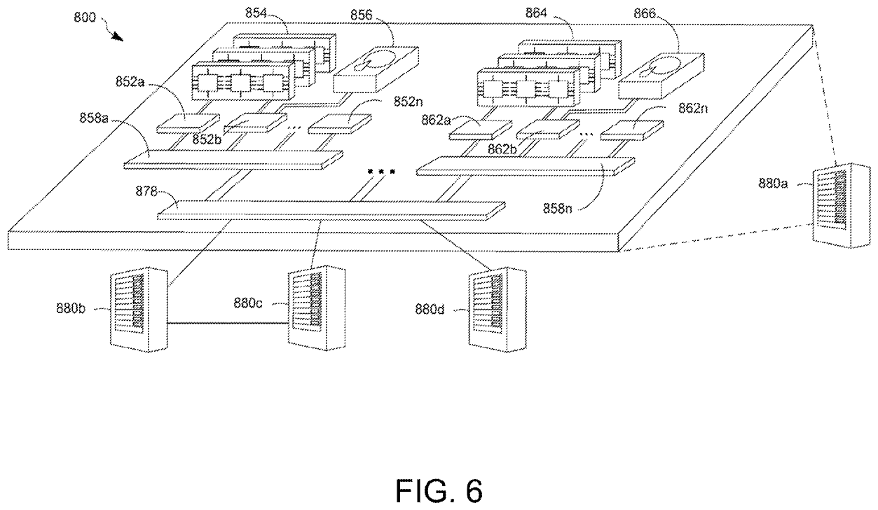

FIG. 6 shows an example of a generic computer device 800, which may be search engine 106 of FIG. 1, which may be used with the techniques described here. Computing device 800 is intended to represent various example forms of large-scale data processing devices, such as servers, blade servers, datacenters, mainframes, and other large-scale computing devices. Computing device 800 may be a distributed system having multiple processors, possibly including network attached storage nodes, that are interconnected by one or more communication networks. The components shown here, their connections and relationships, and their functions, are meant to be examples only, and are not meant to limit implementations of the inventions described and/or claimed in this document.

Distributed computing system 800 may include any number of computing devices 880. Computing devices 880 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 880a includes multiple racks 858a-858n. Each rack may include one or more processors, such as processors 852a-852n and 862a-862n. The processors may include data processors, network attached storage devices, and other computer controlled devices. In some implementations, one processor may operate as a master processor and control the scheduling and data distribution tasks. Processors may be interconnected through one or more rack switches 858, and one or more racks may be connected through switch 878. Switch 878 may handle communications between multiple connected computing devices 800.

Each rack may include memory, such as memory 854 and memory 864, and storage, such as 856 and 866. Storage 856 and 866 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 856 or 866 may be shared between multiple processors, multiple racks, or multiple computing devices and may include a computer-readable medium storing instructions executable by one or more of the processors. Memory 854 and 864 may include, e.g., volatile memory unit or units, a non-volatile memory unit or units, and/or other forms of computer-readable media, such as a magnetic or optical disks, flash memory, cache, Random Access Memory (RAM), Read Only Memory (ROM), and combinations thereof. Memory, such as memory 854 may also be shared between processors 852a-852n. Data structures, such as an index, may be stored, for example, across storage 856 and memory 854. Computing device 800 may include other components not shown, such as controllers, buses, input/output devices, communications modules, etc.

An entire system may be made up of multiple computing devices 800 communicating with each other. For example, device 880a may communicate with devices 880b, 880c, and 880d, and these may collectively be known as search engine 106. As another example, search engine 106 of FIG. 1 may include two or more computing devices 800. Some of the computing devices may be located geographically close to each other, and others may be located geographically distant. The layout of system 800 is an example only and the system may take on other layouts or configurations.

According to some general aspects, a computer program product may be tangibly embodied on a non-transitory computer-readable storage medium and may include instructions that, when executed by at least one computing device, are configured to cause the at least one computing device to detect a prefetch trigger associated with a content portion of content provided by a client device, encrypt the content portion, in response to the prefetch trigger, to obtain an encrypted content portion, transmit the encrypted content portion to a search server, receive encrypted search results from the search server, receive a search request based on the content portion, decrypt the encrypted search results to obtain decrypted search results, and provide the decrypted search results at the client device.

These and other aspects can include one or more of the following, alone or in combination. The instructions, when executed by the at least one computing device, may be further configured to cause the at least one computing device to receive a selection of the content portion, and detect the prefetch trigger, based on the selection. The instructions, when executed by the at least one computing device, may be further configured to cause the at least one computing device to detect a loading of content containing the content portion, perform a classification of text entities of the content, including the content portion, in response to the loading, and detect the prefetch trigger, based on the classification. The instructions, when executed by the at least one computing device, may be further configured to cause the at least one computing device to perform a validation of the content portion with respect to stored validation parameters, and detect the prefetch trigger, based on the validation. The instructions, when executed by the at least one computing device, may be further configured to cause the at least one computing device to classify the content portion as text as having a type, and select the search server, based on the type. The instructions, when executed by the at least one computing device, may be further configured to cause the at least one computing device to determine a search parameter associated with the content portion, encrypt the search parameter to obtain an encrypted search parameter, and transmit the encrypted search parameter with the encrypted content portion to the search server to obtain the encrypted search results based thereon. The instructions, when executed by the at least one computing device, may be further configured to cause the at least one computing device to receive the search request after receipt of the encrypted search results. The instructions, when executed by the at least one computing device, may be further configured to cause the at least one computing device to receive the search request after the detecting of the prefetch trigger and prior to receipt of the encrypted search results. The instructions, when executed by the at least one computing device, may be further configured to cause the at least one computing device to pre-render the decrypted search results, prior to receipt of the search request. The instructions, when executed by the at least one computing device, may be further configured to cause the at least one computing device to select the decrypted search results from among previously-prefetched search results, based on the search request.

According to some general aspects, a method may include detecting a prefetch trigger associated with a content portion of content provided by a client device, encrypting the content portion, in response to the prefetch trigger, to obtain an encrypted content portion, transmitting the encrypted content portion to a search server, receiving encrypted search results from the search server, receiving a search request based on the content portion, decrypting the encrypted search results to obtain decrypted search results, and providing the decrypted search results at the client device.

These and other aspects can include one or more of the following, alone or in combination. Example methods may include receiving a selection of the content portion, and detecting the prefetch trigger, based on the selection. Example methods may include detecting a loading of content containing the content portion, performing a classification of text entities of the content, including the content portion, in response to the loading, and detecting the prefetch trigger, based on the classification. Example methods may include receiving the search request after receipt of the encrypted search results. Example methods may include receiving the search request after the detecting of the prefetch trigger and prior to receipt of the encrypted search results. Example methods may include pre-rendering the decrypted search results, prior to receipt of the search request. Example methods may include selecting the decrypted search results from among previously-prefetched search results, based on the search request.

According to some general aspects, a system may include at least one memory including instructions, and at least one processor that is operably coupled to the at least one memory and that is arranged and configured to execute instructions that, when executed, cause the at least one processor to detect a prefetch trigger associated with a content portion of content provided by a client device, encrypt the content portion, in response to the prefetch trigger, to obtain an encrypted content portion, transmit the encrypted content portion to a search server, receive encrypted search results from the search server, receive a search request based on the content portion, decrypt the encrypted search results to obtain decrypted search results, and provide the decrypted search results at the client device.

These and other aspects can include one or more of the following, alone or in combination. For example, when executed by the at least one processor, the instructions may be further configured to cause the at least one processor to receive a selection of the content portion, and detect the prefetch trigger, based on the selection. When executed by the at least one processor, the instructions may be further configured to cause the at least one processor to detect a loading of content containing the content portion, perform a classification of text entities of the content, including the content portion, in response to the loading, and detect the prefetch trigger, based on the classification.

A number of implementations have been described. Nevertheless, it will be understood that various modifications may be made without departing from the spirit and scope of the description and claims.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Further to the descriptions above, a user is provided with controls allowing the user to make an election as to both if and when systems, programs, devices, networks, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that user information is removed. For example, a user's identity may be treated so that no user information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The computer system (e.g., computing device) may be configured to wirelessly communicate with a network server over a network via a communication link established with the network server using any known wireless communications technologies and protocols including radio frequency (RF), microwave frequency (MWF), and/or infrared frequency (IRF) wireless communications technologies and protocols adapted for communication over the network.

In accordance with aspects of the disclosure, implementations of various techniques described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

Example implementations of the concepts are described herein with reference to cross-sectional illustrations that are schematic illustrations of idealized implementations (and intermediate structures) of example implementations. As such, variations from the shapes of the illustrations as a result, for example, of manufacturing techniques and/or tolerances, are to be expected. Thus, example implementations of the described concepts should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of example implementations.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents will now occur to those skilled in the art. It is, therefore, to be understood that the appended claims are intended to cover such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

1. A computer program product, the computer program product being tangibly embodied on a non-transitory computer-readable storage medium and comprising instructions that, when executed by at least one computing device, are configured to cause the at least one computing device to:
detect a prefetch trigger associated with a content portion of content provided by a client device;
encrypt the content portion, in response to the prefetch trigger, to obtain an encrypted content portion;
transmit the encrypted content portion to a search server;
receive encrypted search results from the search server;
receive a search request based on the content portion;
decrypt the encrypted search results to obtain decrypted search results; and
provide the decrypted search results at the client device.

2. The computer program product of claim 1, wherein the instructions, when executed by the at least one computing device, are further configured to cause the at least one computing device to:
receive a selection of the content portion; and
detect the prefetch trigger, based on the selection.

3. The computer program product of claim 1, wherein the instructions, when executed by the at least one computing device, are further configured to cause the at least one computing device to:
detect a loading of content containing the content portion;
perform a classification of text of the content, including the content portion, in response to the loading; and
detect the prefetch trigger, based on the classification.

4. The computer program product of claim 1, wherein the instructions, when executed by the at least one computing device, are further configured to cause the at least one computing device to:
perform a validation of the content portion with respect to stored validation parameters; and
detect the prefetch trigger, based on the validation.

5. The computer program product of claim 1, wherein the instructions, when executed by the at least one computing device, are further configured to cause the at least one computing device to:
classify the content portion as having a type; and
select the search server, based on the type.

6. The computer program product of claim 1, wherein the instructions, when executed by the at least one computing device, are further configured to cause the at least one computing device to:
determine a search parameter associated with the content portion;
encrypt the search parameter to obtain an encrypted search parameter; and
transmit the encrypted search parameter with the encrypted content portion to the search server to obtain the encrypted search results based thereon.

7. The computer program product of claim 1, wherein the instructions, when executed by the at least one computing device, are further configured to cause the at least one computing device to:
receive the search request after receipt of the encrypted search results.

8. The computer program product of claim 1, wherein the instructions, when executed by the at least one computing device, are further configured to cause the at least one computing device to:
receive the search request after the detecting of the prefetch trigger and prior to receipt of the encrypted search results.

9. The computer program product of claim 1, wherein the instructions, when executed by the at least one computing device, are further configured to cause the at least one computing device to:
pre-render the decrypted search results, prior to receipt of the search request.

10. The computer program product of claim 1, wherein the instructions, when executed by the at least one computing device, are further configured to cause the at least one computing device to:
select the decrypted search results from among previously-prefetched search results, based on the search request.

11. A method comprising:
detecting a prefetch trigger associated with a content portion of content provided by a client device;
encrypting the content portion, in response to the prefetch trigger, to obtain an encrypted content portion;
transmitting the encrypted content portion to a search server;
receiving encrypted search results from the search server;
receiving a search request based on the content portion;
decrypting the encrypted search results to obtain decrypted search results; and
providing the decrypted search results at the client device.

12. The method of claim 11, further comprising:
receiving a selection of the content portion; and
detecting the prefetch trigger, based on the selection.

13. The method of claim 11, further comprising:
detecting a loading of content containing the content portion;
performing a classification of text entities of the content, including the content portion, in response to the loading; and
detecting the prefetch trigger, based on the classification.

14. The method of claim 11, further comprising:
receiving the search request after receipt of the encrypted search results.

15. The method of claim 11, further comprising:
receiving the search request after the detecting of the prefetch trigger and prior to receipt of the encrypted search results.

16. The method of claim 11, further comprising:
pre-rendering the decrypted search results, prior to receipt of the search request.

17. The method of claim 11, further comprising:
selecting the decrypted search results from among previously-prefetched search results, based on the search request.

18. A system comprising:
at least one memory including instructions; and
at least one processor that is operably coupled to the at least one memory and that is arranged and configured to execute the instructions that, when executed, cause the at least one processor to
detect a prefetch trigger associated with a content portion of content provided by a client device;
encrypt the content portion, in response to the prefetch trigger, to obtain an encrypted content portion;
transmit the encrypted content portion to a search server;
receive encrypted search results from the search server;
receive a search request based on the content portion;
decrypt the encrypted search results to obtain decrypted search results; and
provide the decrypted search results at the client device.

19. The system of claim 18, wherein the instructions, when executed by the at least one processor, are further configured to cause the at least one processor to:
receive a selection of the content portion; and
detect the prefetch trigger, based on the selection.

20. The system of claim 18, wherein the instructions, when executed by the at least one processor, are further configured to cause the at least one processor to:
detect a loading of content containing the content portion;
perform a classification of text entities of the content, including the content portion, in response to the loading; and
detect the prefetch trigger, based on the classification.
